(19) United States
(12) Patent Application Publication
(10) Pub. No.: US 2019/0041921 A1
(43) Pub. Date: Feb. 7, 2019

(54) DEVICE CASING

(71) Applicants: LITE-ON ELECTRONICS (GUANGZHOU) LIMITED, GUANGZHOU (CN); LITE-ON TECHNOLOGY CORPORATION, Taipei (TW)

(72) Inventors: Chung-Nan LIN, Taipei (TW); Guan-Hua FU, Taipei (TW)

(21) Appl. No.: 15/864,105

(22) Filed: Jan. 8, 2018

(30) Foreign Application Priority Data
Aug. 1, 2017 (CN) 201720948234.8

(51) Int. Cl. G06F 1/18

(52) U.S. Cl. CPC G06F 1/181

(57) ABSTRACT

A device casing including a bottom plate, a first side plate, a second side plate opposite to the first side plate, a third side plate and two pivoting elements is provided. The bottom plate is connected to the first side plate and the second side plate respectively to form a U-shaped frame having an opening end opposite to the bottom plate. The third side plate is pivotally connected to the first side plate and the second side plate respectively. The two pivoting elements are configured to fix but rotatably connect the third side plate to the first side plate and the second side plate respectively. The two pivoting elements are adjacent to the opening end. The third side plate whose axis of rotation is an imaginary line connecting the two pivoting elements is optionally movable between a closed position and an opened position.

This application claims the benefit of People's Republic of China application Serial No. 201720948234.8, filed Aug. 1, 2017, the subject matter of which is incorporated herein by reference.

### BACKGROUND OF THE INVENTION

### Field of the Invention

The present invention relates in general to a device casing, and more particularly to a casing having at least one side plate which can be opened by way of rotation.

### Description of the Related Art

Some devices are normally equipped with a casing for protecting and installing internal elements. The casing can further be covered with a decorative panel to improve the aesthetic feeling of the device.

However, when an element needs to be installed within a conventional casing, particularly a casing having a square shape, the element cannot be installed to the casing in a downward or upward vertical direction if the element is too large and the space allowance between the casing and the element is insufficient. Under such circumstance, the casing needs to be disassembled to create a sufficient space for the installation of the element. However, the installation of the element becomes more inconvenient and complicated.

### SUMMARY OF THE INVENTION

The present invention is directed to a device casing with two pivoting elements configured so that the third side plate is fixed to but rotatably connected to the first side plate and the second side plate respectively. Moreover, the axis of rotation the third side plate is located at the side of the third side plate farther away from the bottom plate. Therefore, the third side plate can be rotated upwardly to expose an opening communicatively interconnected with an internal receiving space. The opening provides a space which facilitates the installation of internal elements and increases the utilization of internal space.

According to one aspect of the present invention, a device casing is provided. The device casing includes a bottom plate, a first side plate, a second side plate, a third side plate and two pivoting elements. The first side plate is disposed opposite to the second side plate. The bottom plate is connected to the first side plate and the second side plate respectively to form a U-shaped frame having an opening end opposite to the bottom plate. The third side plate is pivotally connected to the first side plate and the second side plate respectively. The two pivoting elements are configured to fix but rotatably connect the third side plate to the first side plate and the second side plate respectively. The two pivoting elements are adjacent to the opening end. The third side plate whose axis of rotation is an imaginary line connecting the two pivoting elements is optionally movable between a closed position and an opened position.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an explosion diagram of a device casing according to one embodiment of the present invention.

FIG. 2 is a three dimensional diagram of a device casing according to one embodiment of the present invention illustrating a third side plate located at an opened position.

FIGS. 3A-3C are three dimensional diagrams and partially cross-sectional views of device casings according to different embodiments of the present invention illustrating various implementations of pivoting elements.

FIGS. 4A-4B are three dimensional diagrams and partially cross-sectional views of device casings according to different embodiments of the present invention illustrating various implementations of locking elements.

FIG. 5 is a schematic diagram of a device casing used in practical applications according to one embodiment of the present invention.

### DETAILED DESCRIPTION OF THE INVENTION

Detailed descriptions of the present invention are disclosed below with a number of embodiments. Although the present disclosure does not illustrate all possible embodiments, other embodiments not disclosed in the present disclosure are still applicable. Moreover, the dimension scales used in the accompanying drawings are not based on actual proportion of the product. Therefore, the specification and drawings are for explaining and describing the embodiment only, not for limiting the scope of protection of the present disclosure. Furthermore, in the drawings of the embodiments, some elements are omitted so that technical features of the present invention can be clearly illustrated. Designations common to the accompanying drawings and embodiments are used to indicate identical or similar elements.

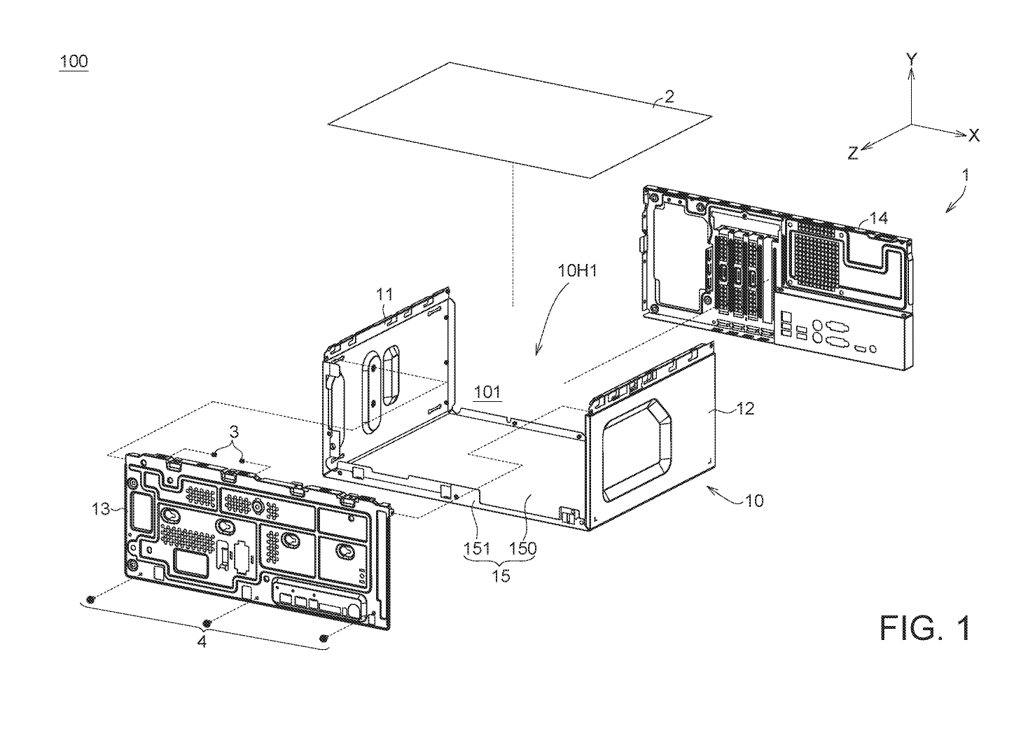

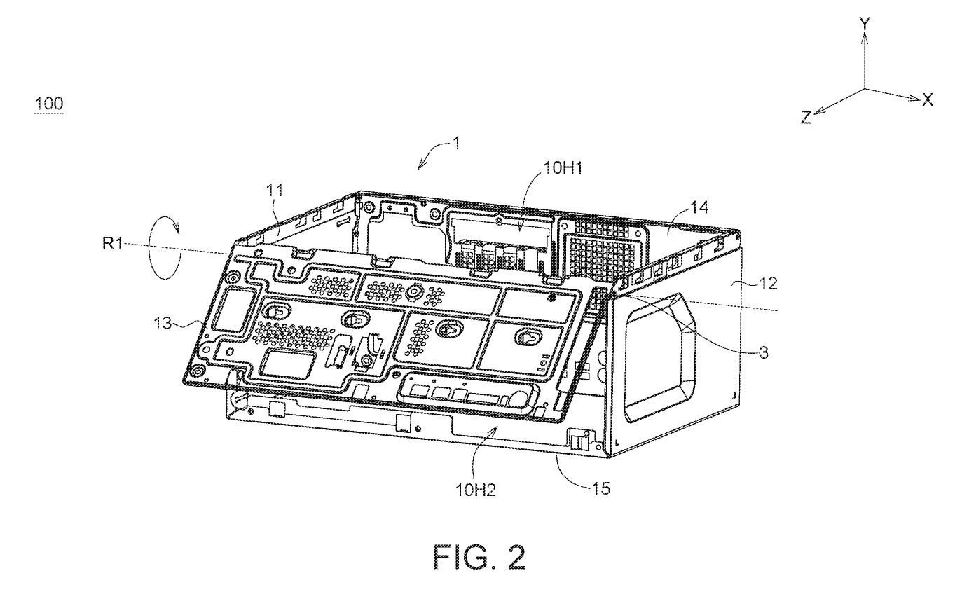

FIG. 1 is an explosion diagram of a device casing 100 according to one embodiment of the present invention. FIG. 2 is a three dimensional diagram of a device casing 100 according to one embodiment of the present invention. To conveniently describe the features of the present invention, the device casing 100 may, for example, be a computer casing. It should be noted that the said exemplification is for explanatory purpose only, not for limiting the scope of the present invention. In practical applications, the device casing 100 may be realized by other types of device casing.

Referring to FIG. 1, the device casing 100 may include a casing body 1, a top plate 2 and a third side plate 13. The top plate 2 and the third side plate 13 may be combined with the casing body 1 through assembling. The casing body 1 may include a first side plate 11, a second side plate 12, a fourth side plate 14 and a bottom plate 15. The first side plate 11 and the second side plate 12 are disposed oppositely. The third side plate 13 and the fourth side plate 14 are disposed oppositely.

In one embodiment, the third side plate 13 may be a front plate of a computer casing, and the fourth side plate 14 may be a rear plate of a computer casing. The external appearances of both the third side plate 13 and the fourth side plate 14 may have multiple openings for exposing multiple electronic elements such as an I/O interface and a power key. Here, terminologies such as the “front” and the “rear” are not used in a restrictive sense, but merely indicate relative relationship in the space.

The bottom plate 15 is connected to the first side plate 11 and the second side plate 12 to form a U-shaped frame 10. In one embodiment, the first side plate 11, the bottom plate 15 and the second side plate 12 may be integrally formed in one piece into the U-shaped frame 10. Or, the first side plate 11, the bottom plate 15 and the second side plate 12 may be integrally formed as a single sheet, which is further bent to form the U-shaped frame 10. In some embodiments, the first side plate 11, the bottom plate 15 and the second side plate 12 may be three independent one-sheet structures, which are further assembled to form the U-shaped frame 10. Or, two of the first side plate 11, the bottom plate 15 and the second side plate 12 may be integrally formed as a one-piece structure and the other one may be an independent one-sheet structure, which is further assembled with the integrally formed one-piece structure to form the U-shaped frame 10.

In one embodiment, the fourth side plate 14 and the first side plate 11 are integrally formed as a one-piece L-shaped frame, and the second side plate 12 and the bottom plate 15 are integrally formed as a one-piece L-shaped frame. Then, the two L-shaped frames may be assembled to form the casing body 1. In another embodiment, the fourth side plate 14 and the second side plate 12 are integrally formed as a one-piece L-shaped frame, and the first side plate 11 and the bottom plate 15 are integrally formed as a one-piece L-shaped frame. Then, the two L-shaped frames may be assembled to form the casing body 1. In yet another embodiment, the first side plate 11, the second side plate 12, the fourth side plate 14 and the bottom plate 15 may be four independent single-sheet structures, which may be assembled together to form the casing body 1. In some embodiments, the first side plate 11, the second side plate 12 and the bottom plate 15 may be connected to form the U-shaped frame 10 and then, the U-shaped frame 10 and the fourth side plate 14 may be integrally formed in one piece to form the casing body 1.

The U-shaped frame 10 defines a receiving space 101, and has an opening end 10H1 whose opening faces a positive Y-axis direction. The opening end 10H1 is communicatively interconnected with the receiving space 101 and is opposite to the bottom plate 15. The opening end 10H1 may receive an electronic element, such as a motherboard, such that the electronic element may be received in the receiving space 101. Here, the top plate 2 may be used to close the opening end 10H1 to avoid dust or dirt landing on the receiving space 101. Moreover, the top plate 2 may be detachably disposed at the opening end 10H1 to facilitate the assembly, disassembly and maintenance of the electronic element.

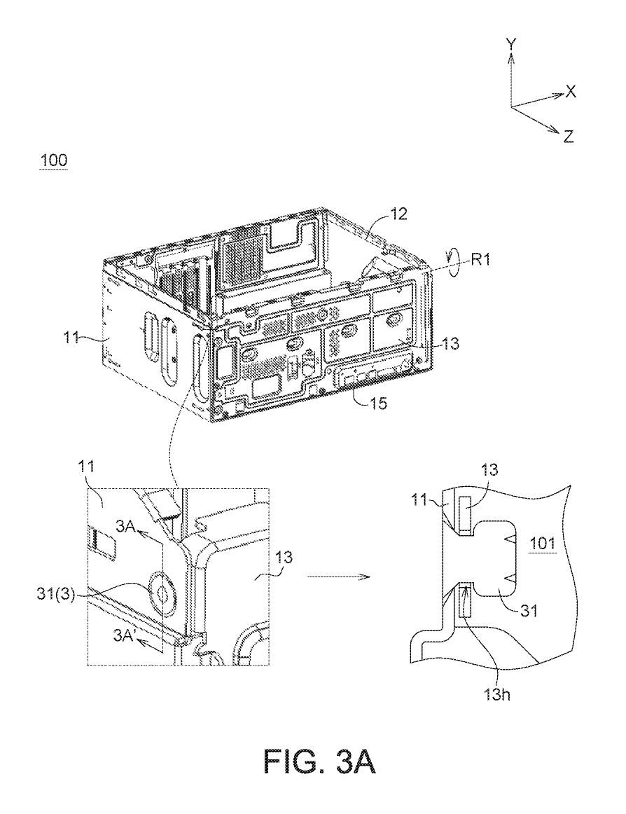

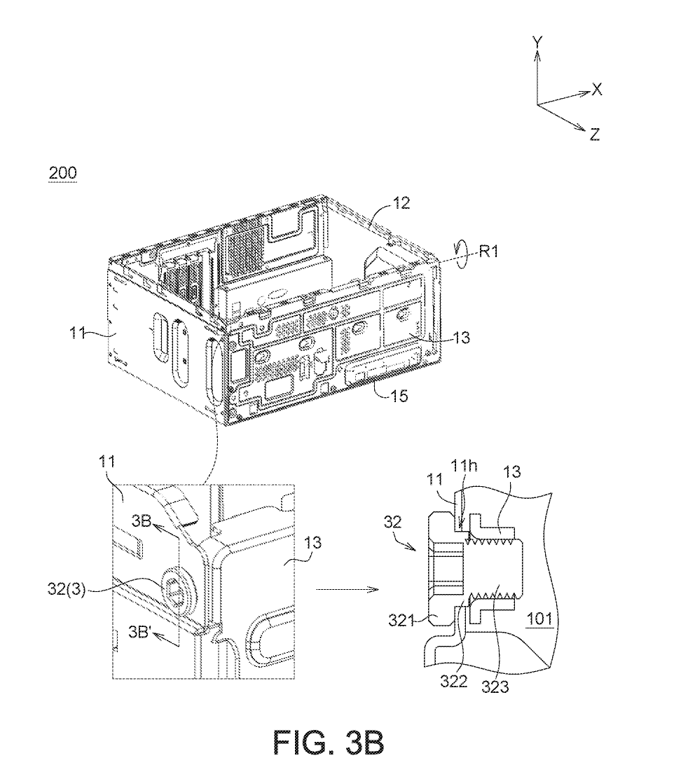

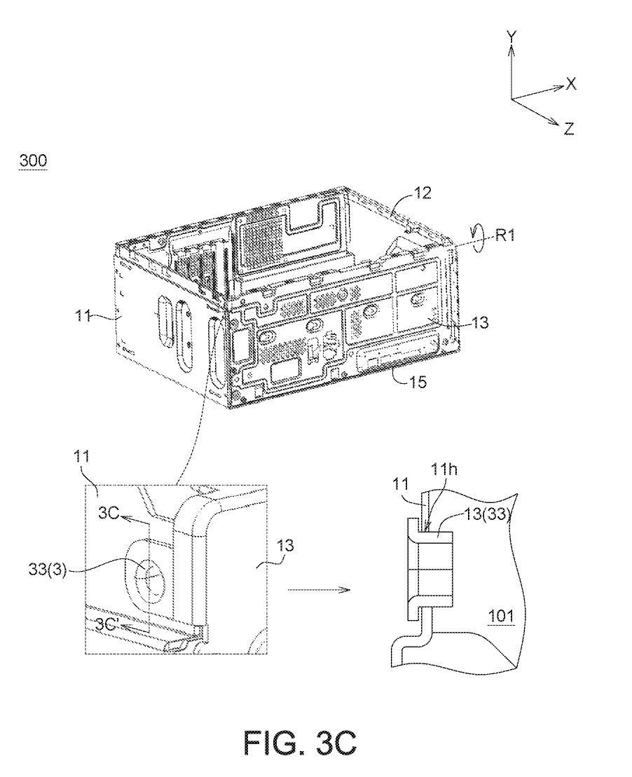

Refer to FIG. 1 and FIG. 2. The third side plate 13 is pivotally connected to the first side plate 11 and the second side plate 12. To put it in greater details, the third side plate 13 is fixed to but rotatably connected to the first side plate 11 and the second side plate 12 respectively. That is, the third side plate 13 can only be rotated but cannot be linearly moved with respect to the first side plate 11 and the second side plate 12. As indicated in FIG. 2, the third side plate 13 is rotated around the axis of rotation R1, so that the third side plate 13 is optionally movable between a closed position (such as the position of the third side plate 13 as indicated in FIG. 3A) and an opened position (such as the position of the third side plate 13 as indicated in FIG. 2).

The device casing 100 includes two pivoting elements 3. The rotation of the third side plate 13 is realized through the two pivoting elements 3. Specifically, the two pivoting elements 3 are disposed adjacent to the opening end 10H1, and the imaginary line connecting the two pivoting elements 3 is used as the axis of rotation R1 of the third side plate 13. That is, the axis of rotation R1 of the third side plate 13 is located at the top side of the third side plate 13, so that the third side plate 13 may be opened upwardly (i.e., positive Y-axis direction) to expose another opening 10H2 whose opening faces a positive Z-axis direction (illustrated in FIG. 2). Therefore, the receiving space 101 may be communicatively interconnected with the exterior through the opening end 10H1 and the opening 10H2. Based on the above design, when the opening end 10H1 receives the electronic element, such as a motherboard, the opening 10H2 provides a space which facilitates the installation of the motherboard (details are described below).

To put it in greater details, the two pivoting elements 3 enable the third side plate 13 to be pivotally connected to the first side plate 11 and the second side plate 12 respectively at the top side of the third side plate 13 (that is, the side of the third side plate 13 closer to the opening end 10H1). The said design may further avoid the first side plate 11 and the second side plate 12 from being turned over outwards. Due to the structural limitation of the U-shaped frame 10, the sides of the first side plate 11 and the second side plate 12 which are closer to the opening end 10H1 are more likely to turn over outwards. To resolve the problem of the first side plate 11 and the second side plate 12 being turned over outwards easily, the two pivoting elements 3 are used at the respective sides of the first side plate 11 and the second side plate 12 closer to the opening end 10H1 so that the first side plate 11 and the second side plate 12 come towards the third side plate 13 or the receiving space 101. Moreover, such a design may avoid the outward turnover problem only by using two pivoting elements 3, and thus there is no need to enhance the structural stiffness of the first side plate 11 and the second side plate 12 by using extra materials. Therefore, the manufacturing costs may be further reduced.

On the other hand, for some conventional casings, the axis of rotation of which is located at the bottom side of the third side plate (that is, at the side of the third side plate closer to the bottom plate). However, when the axis of rotation is located at the bottom side of the third side plate, the problem of the first side plate and the second side plate being turned over outwards easily cannot be resolved. To resolve this problem, more materials need to be added to the left and right sides of the third side plate to connect and pull the first side plate and the second side plate inwards. However, the manufacturing costs will be increased. In the present invention, it may effectively resolve the outward turnover problem by locating the axis of rotation R1 of the third side plate 13 to the top side of the third side plate 13.

Implementation details of the two pivoting elements 3 are disclosed below with accompanying drawings FIGS. 3A-3C. In the following embodiments, the two pivoting elements 3 enable the third side plate 13 to be pivotally connected to the first side plate 11 and the second side plate 12 respectively at the side of the third side plate 13 farther away from the bottom plate 15 (that is, at the top side of the third side plate 13). The embodiments disclosed below are for exemplary and explanatory purposes only, not for limiting the scope of protection of the present invention. That is, the pivoting elements 3 of present invention are not limited to the following exemplification.

Referring to FIG. 3A, a three dimensional diagram and a partially cross-sectional view of the device casing 100 of FIG. 1 are shown. In the present embodiment, the two pivoting elements 3 are realized by two rivets 31. Refer to the cross-sectional view along a cross-sectional line 3A-3A′ of FIG. 3A. The side of the third side plate 13 farther away from the bottom plate 15 may have a pivoting hole 13h; and one of the rivets 31 passes through the pivoting hole 13h of the third side plate 13 from the interior of the receiving space 101 to be joined to the side of the first side plate 11 farther away from the bottom plate 15. Similarly, the other rivet 31 may be joined to the second side plate 12 opposite to the first side plate 11 in the same way. Since the two rivets 31 pass through the third side plate 13 from the interior of the receiving space 101 to be joined to the first side plate 11 and the second side plate 12 respectively, the rivets 31 may enable the first side plate 11 and the second side plate 12 to come towards the third side plate 13 or the receiving space 101, particularly, may enable the sides of the first side plate 11 arid the second side plate 12 farther away from the bottom plate 15 to come inwards. Moreover, there is no relative movement between the rivet 31 and the first side plate 11 or between the rivet 31 and the second side plate 12; however, the pivoting holes 13h may enable the third side plate 13 to rotate freely around the axis of rotation R1. Therefore, the third side plate 13 may rotate around the axis of rotation R1 with respect to the first side plate 11 and the second side plate 12.

Referring to FIG. 3B, a three dimensional diagram and a partially cross-sectional view of the device casing 200 according to another embodiment of the present invention are shown. In the present embodiment, the two pivoting elements 3 are realized by two step screws 32. Refer to the cross-sectional view along a cross-sectional line 3B-3B′ of FIG. 3B. The step screw 32 may include a flat head portion 321, a smooth portion 322 and a thread portion 323. The side of the first side plate 11 farther away from the bottom plate 15 may have a pivoting hole 11h, and one of the step screws 32 passes through the pivoting hole 11h of the first side plate 11 from the outside of the first side plate 11 (that is, the exterior of the receiving space 101) to be joined to the side of the third side plate 13 farther away from the bottom plate 15. To put it in greater details, the step screw 32 is engaged with the third side plate 13 through the thread portion 323. After the step screw 32 is engaged with the third side plate 13, the flat head portion 321 is exposed outside the first side plate 11, and the smooth portion 322 is pivotally connected to pivoting hole 11h. Similarly, the other step screw 32 may also pass through the pivoting hole (not illustrated), disposed at the side of the second side plate 12 farther away from the bottom plate 15, from the exterior of the receiving space 101 to be joined to the side of the third side plate 13 farther away from the bottom plate 15. Since the two step screws 32 respectively pass through the first side plate 11 and the second side plate 12 from the exterior of the receiving space 101 to be joined to the third side plate 13, the step screws 32 may enable the first side plate 11 and the second side plate 12 respectively to come towards the third side plate 13 or the receiving space 101, particularly, may enable the sides of the first side plate 11 and the second side plate 12 farther away from the bottom plate 15 to come inwards. Moreover, although there is no relative movement between the step screws 32 and the third side plate 13, the pivoting holes 11h may enable the smooth portions 322 to rotate freely around the axis of rotation R1. Therefore, the third side plate 13 may rotate with respect to the first side plate 11 and the second side plate 12 through the smooth portions 322.

Referring to FIG. 3C, a three dimensional diagram and a partially cross-sectional view of the device casing 300 according to still another embodiment of the present invention are shown. In the present embodiment, the two pivoting elements 3 are realized by two plugs 33. Refer to the cross-sectional view along a cross-sectional line 30-30′ of FIG. 3C. The side of the first side plate 11 farther away from the bottom plate 15 may have a pivoting hole 11h, and the side of the third side plate 13 farther away from the bottom plate 15 can be designed to have two plugs 33, and one of the plugs 33 passes through the pivoting hole 11h of the first side plate 11 from the outside of the first side plate 11 (that is, the exterior of the receiving space 101) to be pivotally connected to the pivoting hole 11h. Similarly, the other plug 33 may also pass through the pivoting hole (not illustrated) of the side of the second side plate 12 farther away from the bottom plate 15 from the exterior of the receiving space 101 to be pivotally connected to the pivoting hole. Since the two plugs 33 respectively pass through the pivoting hole 11h of the first side plate 11 and the pivoting hole of the second side plate 12 from the exterior of the receiving space 101 to be pivotally connected, the plugs 33 may enable the first side plate 11 and the second side plate 12 to come towards the receiving space 101, particularly, may enable the sides of the first side plate 11 and the second side plate 12 farther away from the bottom plate 15 to come inwards. Moreover, the pivoting holes 11h may enable the plugs 33 of the third side plate 13 to rotate freely around the axis of rotation R1. Therefore, the third side plate 13 may rotate with respect to the first side plate 11 and the second side plate 12.

Through the implementations of the pivoting elements 3 disclosed above, the third side plate 13 may be fixed to but rotatably connected to the first side plate 11 and the second side plate 12 to achieve the object of the present invention. Furthermore, the first side plate 11 and the second side plate 12 may come towards the third side plate 13 or the receiving space 101, particularly, the sides of the first side plate 11 and the second side plate 12 farther away from the bottom plate 15 may come inwards to avoid the first side plate 11 or the second side plate 12 being turned over outwards.

In addition, as indicated in FIG. 1, the device casing 100 may further include a locking element 4. When the third side plate 13 is located at a close position, the locking element 4 may be used to fix the third side plate 13 to the U-shaped frame 10.

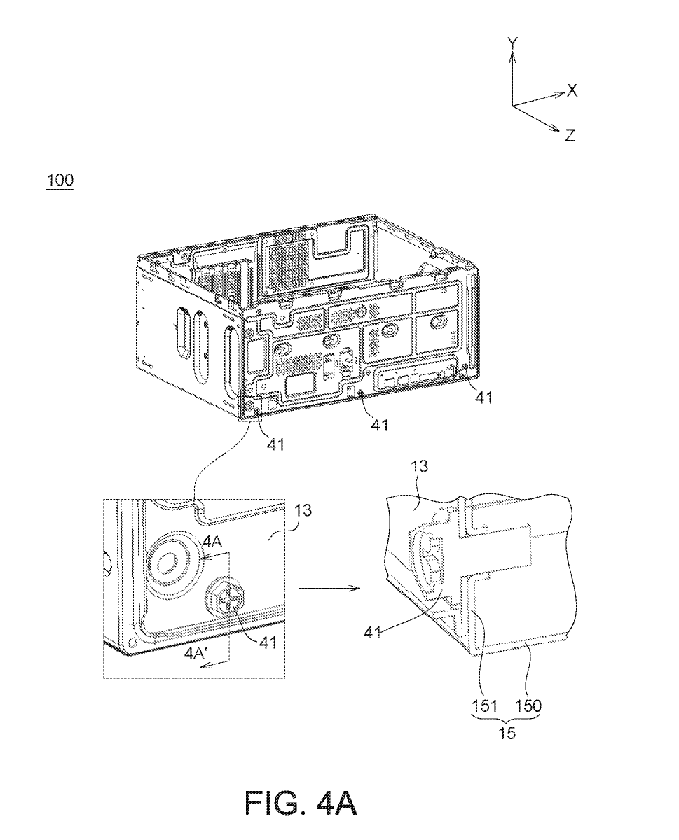

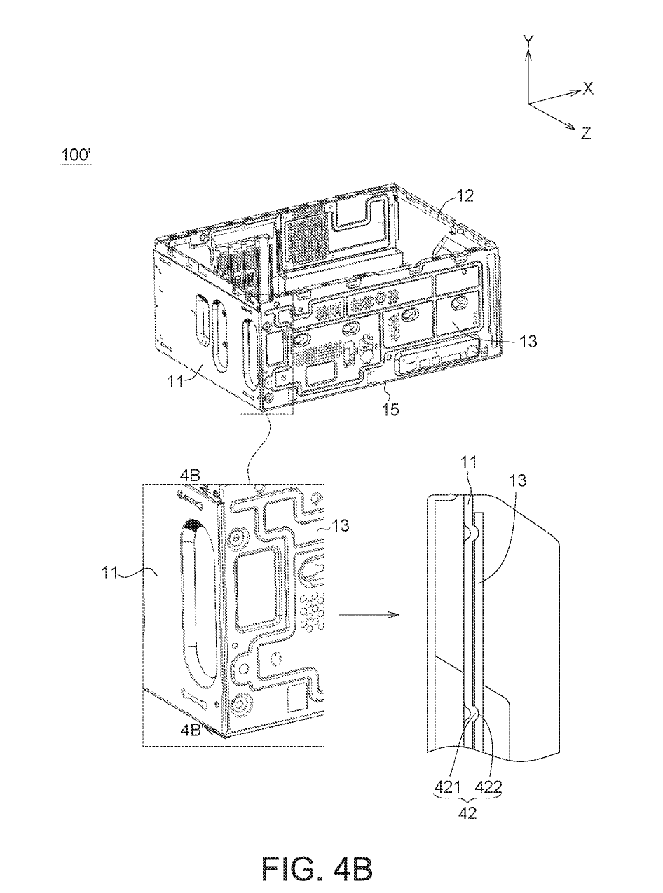

Implementation details of the locking element 4 are disclosed below with accompanying drawings FIGS. 4A-4B. The embodiments described below are for exemplary and explanatory purposes only, not for limiting the scope of protection of the present invention. That is, the locking element 4 of the present invention is not limited to the following exemplification.

Referring to FIG. 4A, a three dimensional diagram and a partially cross-sectional view of the device casing 100 of FIG. 1 are shown. In the present embodiment, the locking element 4 is realized by a screw 41. Although three screws 41 are illustrated in FIG. 4A, the quantity of screws 41 is not limited thereto. For example, the quantity of screws 41 may be one, two or more than two. Refer to the cross-sectional view along a cross-sectional line 4A-4A of FIG. 4A. The bottom plate 15 may include a bottom portion 150 and an extending portion 151, wherein the extending portion 151 extends towards a positive Y-axis direction from the bottom portion 150, and the screw 41 passes through the third side plate 13 to be fastened to the extending portion 151 of the bottom plate 15 to fix the third side plate 13 to the bottom plate 15.

Referring to FIG. 4B, a three dimensional diagram and a partially cross-sectional view of the device casing 100′ according to another embodiment of the present invention are shown. In the present embodiment, the locking element 4 is realized by a buckle structure 42. Refer to the cross-sectional view along a cross-sectional line 4B-4B′ of FIG. 4B. The buckle structure 42 may be formed by using the structures of the first side plate 11 and the third side plate 13 themselves. For example, the first side plate 11 itself may have multiple bumps 421, and the third side plate 13 itself may have a corresponding number of recessed portions 422. The bumps 421 may be engaged in the corresponding recessed portions 422, such that the third side plate 13 may be fixed to the first side plate 11. In FIG. 4B, a cross-sectional view along a cross-sectional line 4B-4B′ is illustrated. However, it should be understood that the buckle structure 42 may also be interposed between the third side plate 13 and the second side plate 12 and/or between the third side plate 13 and the bottom plate 15. Additionally, one or more than one buckle structure 42 may be interposed between the third side plate 13 and the first side plate 11. Similarly, one or more than one buckle structure 42 may be interposed between the third side plate 13 and the second side plate 12 and/or between the third side plate 13 and the bottom plate 15.

In the above embodiments, the fourth side plate 14 disposed opposite to the third side plate 13 may be fixedly connected to the first side plate 11 and the second side plate 12, and only the third side plate 13 is rotatable. However, the present invention is not limited there to. In another embodiment, the fourth side plate 14 may be pivotally connected to the first side plate 11 and the second side plate 12, just in the same way as the third side plate 13. That is, the fourth side plate 14 may be pivotally connected to the sides of the first side plate 11 and the second side plate 12 farther away from the bottom plate 15.

Based on the design of the device casings 100, 200, 300 and 100′ disclosed in above embodiments, when the opening end 10H1 receives the electronic element, such as the motherboard, the opening 10H2 provides a space which facilitates the installation of the motherboard.

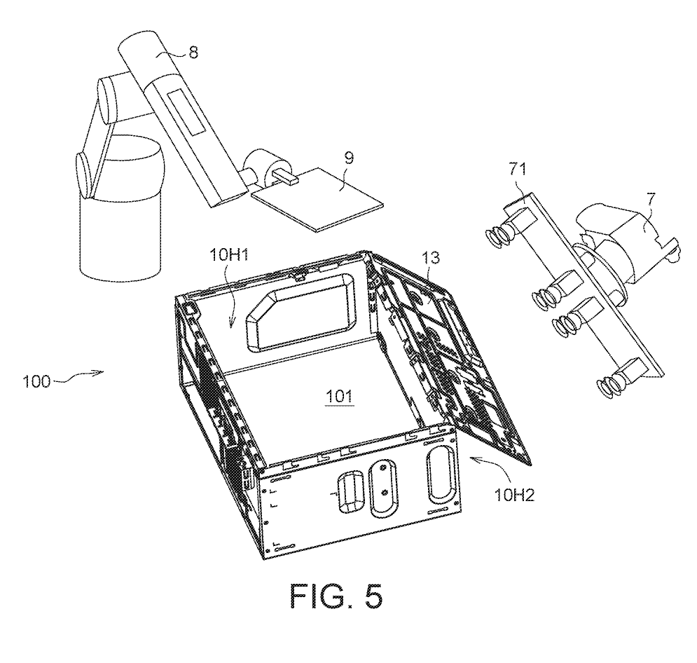

Referring to FIG. 5, a schematic diagram of a device casing 100 used in practical applications according to one embodiment of the present invention is shown. Examples of practical application may include assembly using an automation equipment. When a motherboard 9 needs to be installed in the receiving space 101, a first robot arm 7 may be used to rotate the third side plate 13 upwards to an opened position. For example, the first robot arm 7 may have a suction module 71 capable of rotating the third side plate 13 upwards by suction to the opened position to expose the opening 10H2, which provides a space which facilitates the installation of the motherboard 9. Then, a second robot arm 8 may be used to install the motherboard 9 from the opening end 10H1 to the receiving space 101 without having to precisely adjust the motherboard 9 to a specific angle, such that the complexity of installation can be reduced. Lastly, a locking element 4 is used to fix the third side plate 13 to the U-shaped frame 10 (illustrated in FIG. 1).

On the other hand, the second robot arm 8 may be used to install the motherboard 9 from the opening 10H2 to the receiving space 101. Or, when the first robot arm 7 rotates the third side plate 13 upwards to the opened position, the second robot arm 8 may install the motherboard 9 from the opening end 10H1 to the receiving space 101, and an additional robot arm may further be used to install other electronic elements from the opening 10H2 to the receiving space 101 to increase the speed of installation.

According to the embodiments disclosed above, two pivoting elements are configured so that the third side plate is fixed to but rotatably connected to the first side plate and the second side plate respectively. Moreover, the axis of rotation of the third side plate is located at the side of the third side plate farther away from the bottom plate. Therefore, the third side plate may be rotated upwards to expose an opening communicatively interconnected with an internal receiving space. The opening provides a space, which facilitates the installation of internal elements and increases the utilization of internal space. Moreover, through the configuration of the two pivoting elements, the first side plate and the second side plate may come towards the third side plate or the receiving space, particularly, the sides of the first side plate and the second side plate farther away from the bottom plate may come inwards. Therefore, the problem of the side of the first side plate and the second side plate farther away from the bottom plate being turned over outwards easily may be resolved without having to enhance the structural stiffness of the first side plate and the second side plate by using extra materials or having to pull the first side plate and the second side plate inwards by adding more materials to the left and right sides of the third side plate.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A device casing comprising:
a bottom plate, a first side plate and a second side plate opposite to the first side plate, wherein the bottom plate is connected to the first side plate and the second side plate respectively to form a U-shaped frame having an opening end opposite to the bottom plate;
a third side plate pivotally connected to the first side plate and the second side plate respectively; and
two pivoting elements configured to fix but rotatably connect the third side plate to the first side plate and the second side plate respectively, wherein the two pivoting elements are adjacent to the opening end;
wherein the third side plate whose axis of rotation is an imaginary line connecting the two pivoting elements is optionally movable between a closed position and an opened position.

2. The device casing according to claim 1, further comprising:
a fourth side plate disposed opposite to the third side plate and pivotally connected to the first side plate and the second side plate respectively.

3. The device casing according to claim 1, further comprising:
a fourth side plate disposed opposite to the third side plate and fixedly connected to the first side plate and the second side plate.

4. The device casing according to claim 3, wherein the fourth side plate and one of the first side plate and the second side plate are integrally formed into a L-shaped frame.

5. The device casing according to claim 3, wherein the bottom plate and one of the first side plate and the second side plate are integrally formed into a L-shaped frame.

6. The device casing according to claim 3, wherein the U-shaped frame and the fourth side plate are integrally formed into a casing body.

7. The device casing according to claim 1, wherein the U-shaped frame forms a receiving space, and each of the two pivoting elements is a rivet passing through the third side plate from an interior of the receiving space to be joined to a corresponding one of the first side plate and the second side plate.

8. The device casing according to claim 1, wherein the U-shaped frame forms a receiving space, and each of the two pivoting elements is a step screw passing through a corresponding one of the first side plate and the second side plate from an exterior of the receiving space to be joined to the third side plate.

9. The device casing according to claim 1, wherein the U-shaped frame forms a receiving space, each of the first side plate and the second side plate has a pivoting hole, the third side plate has two plugs as the two pivoting elements, and each of the two plugs passes through a corresponding one of the pivoting hole from an exterior of the receiving space to be pivotally connected to the corresponding one of the pivoting hole.

10. The device casing according to claim 1, further comprising:
a locking element for fixing the third side plate to the U-shaped frame when the third side plate is located at the closed position.

11. The device casing according to claim 10, wherein the locking element is a screw or a buckle structure.

12. The device casing according to claim 1, wherein the device casing is a case of a computer, and when the third side plate whose axis of rotation is the imaginary line connecting the two pivoting elements is rotated to the opened position, the opening end is adapted to receiving a motherboard.

13. The device casing according to claim 1, further comprising:
a top plate detachably disposed at the opening end.
